(19) United States
(12) Patent Application Publication
(10) Pub. No.: US 2018/0114161 A1
(43) Pub. Date: Apr. 26, 2018

(54) SYSTEMS AND METHODS FOR SUPPLY CHAIN RISK ANALYSIS

(71) Applicant: T3W BUSINESS SOLUTIONS, INC., San Diego, CA (US)

(72) Inventors: Lisa CARMAN, San Diego, CA (US); Charles STONE, San Diego, CA (US)

(73) Assignee: T3W BUSINESS SOLUTIONS, INC., San Diego, CA (US)

(21) Appl. No.: 15/794,921

(22) Filed: Oct. 26, 2017

Related U.S. Application Data
(60) Provisional application No. 62/413,402, filed on Oct. 26, 2016.

(51) Int. Cl. G06Q 10/06; G06Q 50/28

(52) U.S. Cl. CPC G06Q 10/0635; G06Q 50/28; G06Q 10/06315; G06Q 10/0637

(57) ABSTRACT

A system and method for generating impact information based on likelihood of component defect occurrence determination is provided. In one embodiment, the system includes one or more physical processors configured by machine-readable instructions to: obtain supply chain information for a component acquired by a user from a supplier; determine a likelihood of component defect occurrence based on the supply chain information, the defect likelihood reflecting the likelihood of defect occurrence for the component; identify devices that use the component having the likelihood of component defect; and effectuate presentation of the identified devices as an interactive information map.

### REFERENCE TO RELATED APPLICATIONS

This application claims the benefit of U.S. Provisional Patent Application No. 62/413,402 filed on Oct. 26, 2016, the content of which is incorporated herein by reference in its entirety.

### TECHNICAL FIELD

The disclosed technology relates generally to risk management systems, and more particularly, some embodiments relate to systems and methods for supply chain risk analysis.

### BACKGROUND

Many organizations depend on efficient and reliable supply chain analytics. Cyber technology solutions, including information and communications technology (ICT), are sometimes implemented to monitor supply chain status. Problems within an organization's supply chain (e.g., defective parts, counterfeit parts, incorrect parts, delays, shortages, etc.) inhibit production, increase expense, and may contribute to product safety issues. Current supply chain monitoring solutions do not enable the enterprise to visualize and predict risk or global impact to the enterprise that may be caused by possible supply chain problems.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates a system configured for determining a likelihood of component defect occurrence, in accordance with one or more implementations.

FIG. 2 is an exemplary representation of a plurality of repositories storing component identification information, component purchase information, component use information, historical purchase information, historical defect information, and industry standard information, in accordance with one or more implementations.

FIG. 3 illustrates an exemplary determination analysis utilizing component identification information, component purchase information, component use information, historical purchase information, historical defect information, and industry standard information, in accordance with one or more implementations.

FIG. 4 illustrates an exemplary schematic of impact results presentation generated based on a likelihood of component defect occurrence, in accordance with one or more implementations.

FIG. 5 illustrates an example computing component that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Embodiments disclosed herein are directed to systems and methods determining a likelihood of a component defect occurrence (e.g. risk that a component may be defective) within a user supply chain and effects of these occurrences on users within the supply chain. The user may be an institutional user such as an organization or collection of organizations (e.g., various organizations within a large corporate entity), a private entity, and/or any other user. The component may be an information and communications technology component used for the gathering, storing, transmitting, retrieving, or processing of information (e.g., microelectronics, printed circuit boards, computing systems, software, signal processors, mobile telephony, satellite communications, and networks) and/or other component. The component defect occurrence may include an occurrence of counterfeit, gray market, substandard, and/or otherwise compromised component. For example, counterfeit and gray market components may be bought at significantly lower prices than components offered from authorized supply chains and thus often enter the supply chain. The supply chain may include information for providing the component by a supplier to the user. The supplier may include a provider of the component (e.g., manufacturer, distributor, reseller, and/or other provider)

More specifically, some embodiments disclosed herein disclose systems and methods for determining the likelihood of component defect occurrence using supply chain data and/or other internal and external data. The likelihood of the defective component occurrence may be determined by analyzing supply chain data such as supply chain transactions, supplier information, price and availability information, user input, and/or other data using various data analysis techniques (e.g. Bayesian-type statistical analysis). For example, analyzing price data may be useful in determining the likelihood of component defect occurrence because a significantly lower component price may be associated with a higher likelihood that the component may be defective.

Organizational use of a defective component may present a cyber security vulnerability. For example, a component that is determined to have a high likelihood of being defective may be obtained from a supplier that is currently continuing to supply other components within the organization. In some examples, the suspect component may incorporate a suspect sub-component used in other parts of the supply chain. All instances of use associated with the suspect sub-component, component and/or other components supplied by the same supplier may be identified, linked, and assigned risk assessment probabilities (e.g., the probability that a particular assembly (including multiple components), or end-product or system (including multiple assemblies) may include a defective component or sub-component.

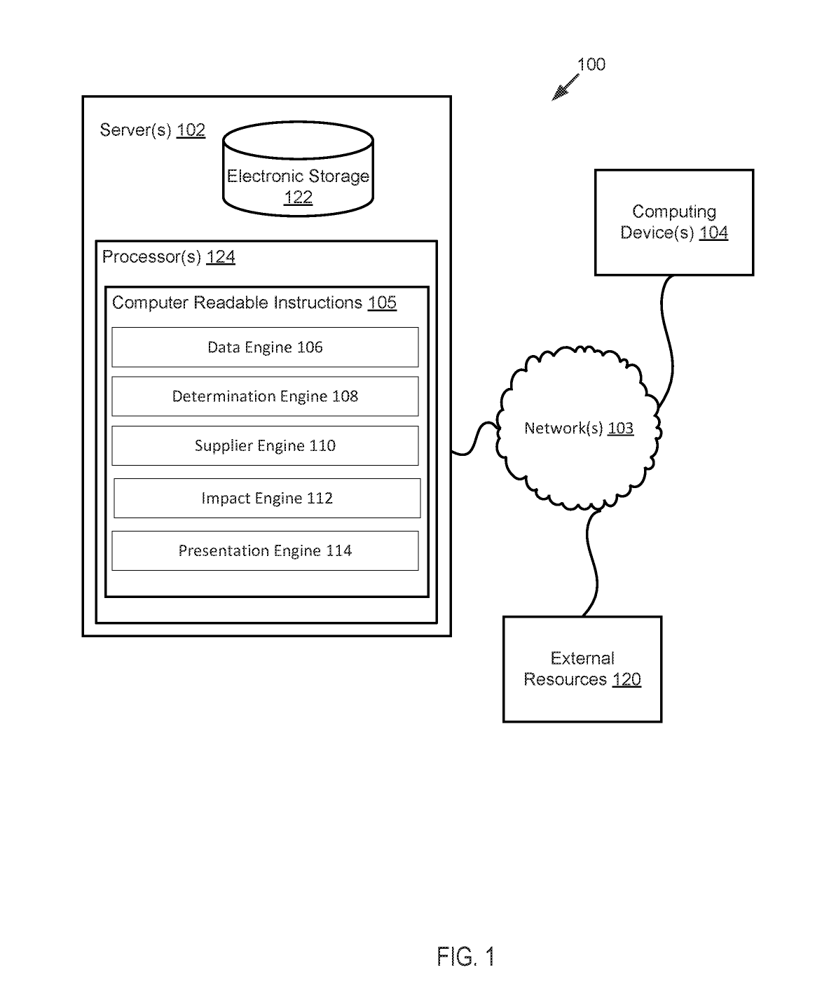

FIG. 1 illustrates a system configured for determining a likelihood of component defect occurrence within a supply chain used by one or more users, determining an impact of the defect occurrence on users based on the likelihood determination, and presenting it to users on client computing devices, in accordance with one or more implementations. As is illustrated in FIG. 1, system 100 may include one or more servers 102. Server(s) 102 may be configured to communicate with one or more client computing device 104 according to a client/server architecture. The users of system 100 may access system 100 via client computing devices(s) 104. Server(s) 102 may be configured to execute one or more computer program components. The computer program components may include one or more of supply chain component 106, determination component 108, supplier component 110, impact component 112, presentation component 114 and/or other components.

Communication network 103 may represent one or more computer networks (e.g., LAN, WAN, or the like) or other transmission mediums. Communication network 103 may provide communication between any of the components of system 100. In some implementations, communication network 103 comprises one or more computing devices, routers, cables, buses, and/or other network topologies. In some implementations, communication network 103 may be wired and/or wireless. In various implementations, communication network 103 may comprise the Internet, one or more networks that may be public, private, IP-based, non-IP based, and so forth. Communication networks and transmission mediums are discussed further herein.

Data engine 106 may be configured to obtain component information for the likelihood of component defect occurrence determination. Component information may include information associated with a component. Component information may include component identification information (e.g., name and type), component purchase information (e.g., price), component use information (e.g., how component is utilized by users), historical purchase information (e.g., past purchase information, purchase trends, irregularities in purchase trends), historical defect information (e.g., whether component is known to have a high likelihood of defect), industry standards information (e.g., information regarding component standards) and/or other relevant information.

Data engine 106 may be configured to obtain component information associated with a component from a repository storing supply chain data (e.g. Supply Management System database, Enterprise Resource Planning databased), a user input, a publicly available source including information associated with the component (e.g., market reports, consumer information, and/or other sources), industry standards information (e.g., Government-Industry Data Exchange Program) and/or other sources of component information.

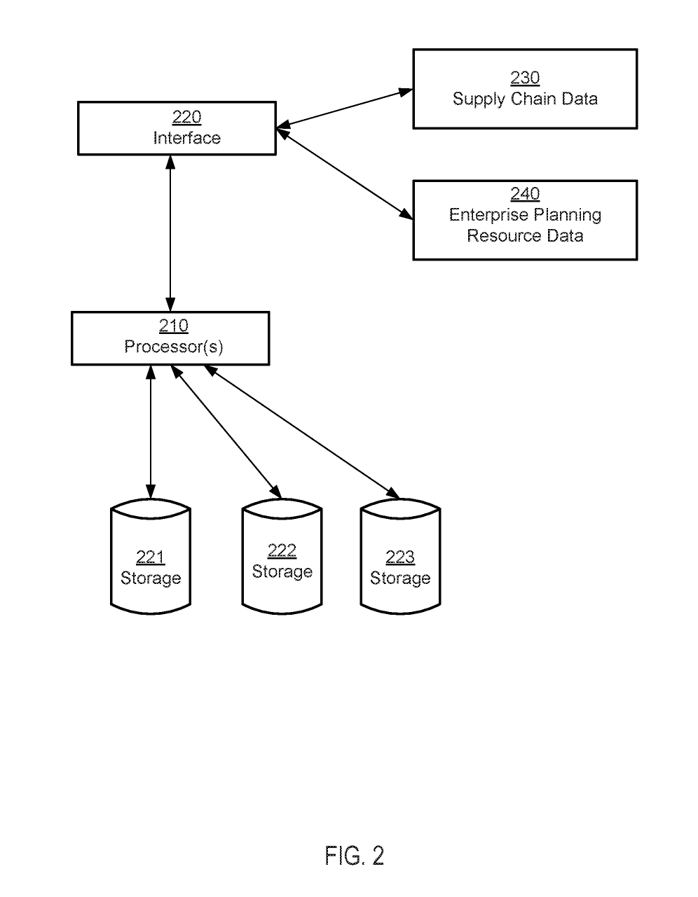

For example, and as illustrated in FIG. 2, system 100 may be configured for communicating with a source providing component information. An example embodiment may have interface 220 capable of communicating with Supply Management System database 230 and Enterprise Resource Planning database 240 storing component information. Interface 220 may be communicatively coupled to local Supply Management System database 230 and Enterprise Resource Planning database 240 located locally as a local hard drive or disk for certain embodiments. In other embodiments, interface 220 may be network interface 220 for component information over a public or private network.

System 100 may also have one or more processors 210 coupled to the interface 220 to obtain component information from Supply Management System database 230 and Enterprise Resource Planning database 240. Processor 210 may also be used to determine component information associated with one or more components, for example. System 100 may also have one or more storage devices 221, 222, and 222 for storing component information and are coupled to processor 210. These storage devices 221, 222, and 222 may include hard drives, arrays of hard drives, and/or other types of storage devices, including distributed storage devices. In some implementations, system 200 may have one processor 210 or employ distributing processing and have more than one processor 210. Other embodiments may also provide from direct communicative coupling between the interface 220 and the storage devices 221, 222, and 222.

Referring back to FIG. 1, determination component 108 may be configured to determine a likelihood of component defect occurrence analyzing information obtained by data engine 106 and/or other information. Information obtained by data engine 106 may include component identification information including component name, component type, component number such as SKU or UPC, and/or other component identifying information.

Component purchase information may include component price offered by the supplier, component price offered by other suppliers, component availability (e.g., how readily available a component is), a type of supplier (e.g., authorized reseller, non-identified reseller, manufacturer, distributor, prime supplier, and/or other type of supplier), and/or other purchase information. For example, a supplier that has been identified within supply chain system as Prime may include suppliers that sub-contractor, a sub-contractor to a sub-contractor, or sub-contractor to a Lead Systems Integrator, may indicate that that the likelihood of components being defective is lower than a supplier that is not prime.

Component use information may include component functional information such as frequency and level of component use (e.g., how component is utilized by users), the connectivity and integration between the component and other components, the dependencies related the component, and/or other component use information.

Historical purchase information may include past purchases of the component, purchasing trends of the component, irregularities in purchase trends, and/or other historical purchase information. For example, irregularities in purchase trends may include a sudden price decrease absent a change in purchase volume. Purchase irregularities may be based on user-set parameters, system generated parameters, and/or other input.

Historical defect information may include historical defect information associated with the component across all suppliers (e.g., whether component is known to have a high likelihood of defect), historical defect information associated specific supplier (e.g., whether a specific supplier is known to supply defective components), historical defect information associated with similar components having the same or similar component information, and/or other historical component information. For example, a component performing similar function from the same supplier as the current component has been identified as defective.

Determination engine 108 may be configured to perform a determination analysis on information obtained by data processor 106 to determine a likelihood of component defect occurrence. The determination analysis may utilize a variety of analytical techniques to analyze collected sets of component identification related data, component purchase related data, component use related data historical purchase related data including, historical defect related data, and industry standards related data obtained from various sources to generate a component defect likelihood indicator.

Determination engine 108 may be configured to determine a likelihood of component defect occurrence using statistical analysis and/or other methodology to calculate the component defect likelihood indicator. Determination component 108 may be configured to assign specificity, relevance, confidence and/or weight to every one of component identification information, component purchase information, component use information, historical purchase information, historical defect information, and industry standards information based on relevance and relationship between each piece of information to one another. Relevance and relationship may be determined using user specified parameters, system generated parameters, and/or other techniques. The assignment of these weight factors may be used in determination of component-specific defect likelihood results. For example, during a likelihood determination a higher weight may be given to a decrease in price for components that have low availability than a decrease in component price for components with above average availability.

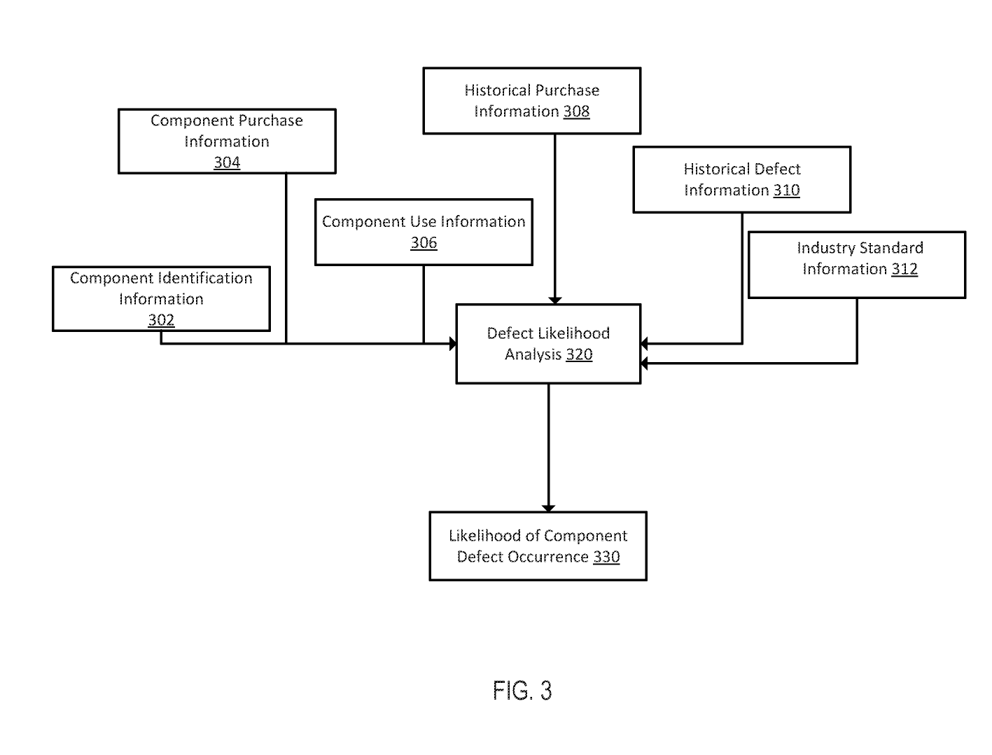

For example, as illustrated by FIG. 3, the determination analysis may include a statistical analysis 330 performed on component identification information 302, component purchase information 304, component use information 306, relevant historical purchase information 308, relevant historical defect information 310, and relevant industry standard information 307. Component identification information 302 may include a storage chassis having a specific model and functional specification supplied by a Prime supplier. Component purchase information 304 may include a purchase price that is comparatively below the purchase price for a similar storage chassis. Component use information 306 may include mission critical data that is stored using the storage chassis. Historical purchase information 308 may include similar prices paid in the past to the Prime supplier. Historical defect information 310 may include information on a large number of storage chassis having similar functional specification being identified as defective. Industry standard information 307 may include guidelines that require storage chassis to be manually verified for warranty. Determination analysis 330 may determine likelihood of incident occurrence 308 to be 35 in 100,000 having component identification information 302, component purchase information 304, component use information 306, historical purchase information 308, historical defect information 310, and industry standard information 307.

Referring back to FIG. 1, in some implementations, determination processor 108 may be configured to assign specificity, relevance, confidence and/or weight to every one of component identification information, component purchase information, component use information, historical purchase information, historical defect information, and industry standard information based on the source of the information. The selection of these weighting factors may be used to augment the predictive power of the likelihood determination analysis. For example, internal supply chain data may be associated with a higher credibility factor, while public market information may be associated with a relatively lower credibility factor.

In some implementations, component identification information, component purchase information, component use information, historical purchase information, historical defect information, and industry standard information and/or other information may be used in conjunction with one or more predictive models. The predictive model(s), in various implementation, may include one or more of neural networks, Bayesian networks (such as Hidden Markov models), expert systems, decision trees, collections of decision trees, support vector machines, or other systems known in the art for addressing problems with large numbers of variables. The specific information analyzed may vary depending on the desired functionality of the particular predictive model.

Determination engine 108 may be configured to determine a likelihood indicator associated with individual components based upon component identification information, component purchase information, component use information, historical purchase information, historical defect information, and industry standard information. Likelihood indicators may be a sliding scale of percentile values (e.g. 10%, 15%, . . . n, where a percentage may reflect likelihood of component defect occurrence), numerical values (e.g., 1, 2, . . . n, where a number may be assigned as low and/or high), verbal levels (e.g., very low, low, medium, high, very high, and/or other verbal levels), and/or any other scheme to represent a likelihood score. Individual component likelihood indicators may have one or more additional likelihood indicators associated with them. An aggregate likelihood indicator may be determined for a number of components based on a combination of likelihood indicators associated with individual components. In some implementations, an aggregate likelihood indicator may be determined for a number of components based on a combination of likelihood indicators associated with the devices in which these components are implemented.

In some implementations, the likelihood of component defect occurrence may be manually entered by a user. Information outside of component information obtained by data engine 106 may indicate that a component has been deemed defective. For example, an authorized dealer may provide information that a component within its inventory that was previously thought to be without defect and was supplied to user's organization was in fact obtained from a non-certified reseller and is out of original manufacturer's warranty, thus making it a gray market component. Thus, a user may enter a likelihood indicator of 100%, for example, for this component.

In some implementations, the components having likelihood indicators determined by determination engine 108 meeting a user-specified threshold parameter may result in generating a message to a user that further analysis may be necessary. The user-specified threshold parameter may be a numeric value, a range of values, and/or any other parameter. For example, a component having a 30% likelihood indicator may prompt a user to perform further analysis including contacting the warranty or service provider associated with the component based on the component information obtained by data engine 106.

In some implementations, a response plan may by generated by determination engine 108 in response to component likelihood indicators meeting a user-specified threshold parameters. The response play may include a toolkit to support further analysis and obtain a more a likelihood indicator having a higher value associated with greater certainty. The toolkit may include one or more of a response plan for identification, analysis, response, and/or other steps based on the indicator information obtained by data component and/or other information. The response plans may be stored within a repository of response plans and/or may be dynamically generated by system 100 in based on component information, user-specified information, and/or other information. For example, a response plan may prompt investigative action (e.g., contacting the supplier) to ascertain whether the likelihood of component defect occurrence is consistent with component being actually defective.

Supplier engine 110 may be configured to determine supplier information for components with a determination of likelihood of component defect occurrence based on component information obtained by data component 108. Supplier information may include supplier name, supplier network (e.g., other suppliers that have been identified as being connected to the supplier such as sub-contractors), history of transactions for the component (e.g. purchase history, back-orders, fulfilled orders, unfilled orders, and/or other types of transactional information), and/or other supplier information.

Impact engine 112 may be configured to determine an impact on the user's supply chain a component with a determination of likelihood of component defect occurrence based on component information obtained by data engine 108 and supplier information obtained by supplier engine 110. The impact the component may have on the user's supply chain may include identification of devices, units, systems, and/or other units that may currently incorporate or may incorporate the component, the role the component plays within identified device(s) (e.g., critical, non-critical, essential, optional, and/or other roles), the replacement cost based on the complexity associated with replacement of the component, availability and cost of a replacement component, availability and cost of a replacement procedure, and/or other factors. Impact engine 112 may be configured to generate an impact value indicator based on the determination of the impact.

Presentation engine 114 may be configure to effectuate presentation of the impact the likelihood of the component defect may have on the supply chain of the user. Presentation engine 114 may be configured to use client computing device(s) 104 to present the incidence likelihood indicator to the user. In some implementations, client computing device(s) 104 may include one or more of a smartphone, a tablet, a mobile device, and/or other displays. A given client computing device 104 may include one or more processors configured to execute computer program components. The computer program components may be configured to enable a user associated with the given client computing device 104 to interface with system 100 and/or external resources 120, and/or provide other functionality attributed herein to client computing device(s) 104.

Presentation engine 114 may present the impact the likelihood of the component defect may have on the supply chain of the user visually. For example, the impact may be presented as a visual interactive map. Various sections of the map may be associated with geographic regions of user's activity. Alternatively, various systems within a user organization (e.g., sub-divisions and command units) may be represented as individual map sections. The information included within the map may be device information including various devices utilized by a user organization, component information, supplier information, and/or other information. The map may visually represent the impact to the user's organization by identifying all devices that include the component having likelihood of being defective. The map may include visual zoom-in and zoom-out capabilities such that devices may appear in clusters and/or individually depending on the zoom level selected. In some implementations, the map may include a detailed or an exploded view capabilities allowing to view details pertaining to devices, components, suppliers, and/or other information.

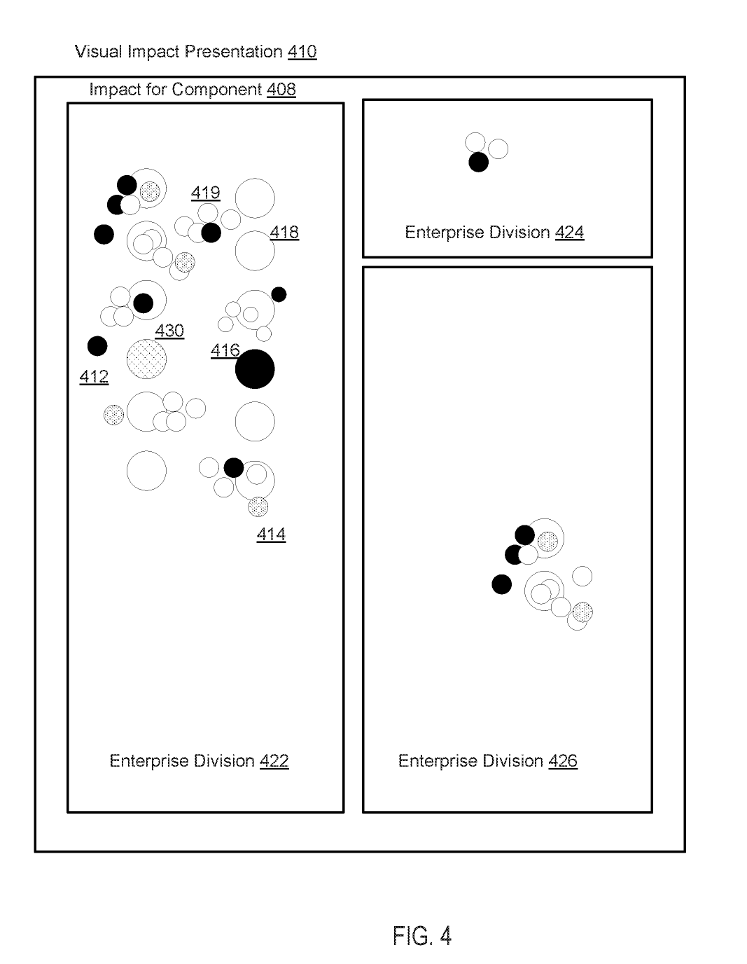

For example, and as illustrate by FIG. 4, visual impact presentation view 410 may represent various systems within an organization including enterprise division 422, enterprise division 424, and enterprise division 426. Each section within presentation 410 may identify devices, components, and suppliers utilized by each of the 422, 424, and 426 organizations. Device 412 represented by a small solid colored circle may include an individual a device heavily dependent on component 408 determined to have a likelihood of being defective. Device 414 represented by a small dotted circle may include an individual device without critical dependency on component 408. Device 419 represented by a small unfilled circle may include an individual device without any dependency on component 408. Cluster of devices 416 represented by a large solid colored circle may include individual devices that are heavily dependent on component 408. Cluster of devices 430 represented by a large dotted circle may include individual devices without critical dependency on component 408. Cluster of devices 418 represented by a large unfilled circle may include individual devices without any dependency on component 408.

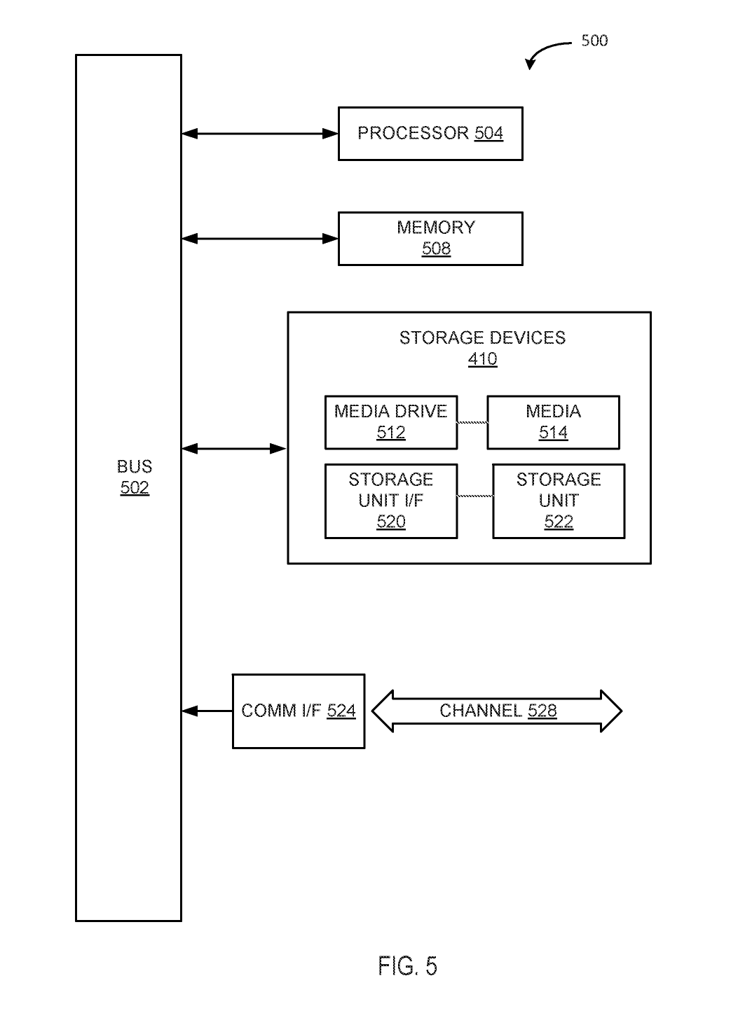

As used herein, the term component might describe a given unit of functionality that can be performed in accordance with one or more embodiments of the technology disclosed herein. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. In implementation, the various components described herein might be implemented as discrete components or the functions and features described can be shared in part or in total among one or more components. In other words, as would be apparent to one of ordinary skill in the art after reading this description, the various features and functionality described herein may be implemented in any given application and can be implemented in one or more separate or shared components in various combinations and permutations. As used herein, the term engine may describe a collection of components configured to perform one or more specific tasks. Even though various features or elements of functionality may be individually described or claimed as separate components or engines, one of ordinary skill in the art will understand that these features and functionality can be shared among one or more common software and hardware elements, and such description shall not require or imply that separate hardware or software components are used to implement such features or functionality.

Where engines or components of the technology are implemented in whole or in part using software, in one embodiment, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the technology using other computing components or architectures.

Referring now to FIG. 5, computing component 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, digital cameras, navigation systems, cellular telephones, portable computing devices, modems, routers, WAPs, terminals and other electronic devices that might include some form of processing capability.

Computing component 500 might include, for example, one or more processors, controllers, control components, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of computing component 500 or to communicate externally.

Computing component 500 might also include one or more memory components, simply referred to herein as main memory 508. For example, preferably random access memory (RAM) or other dynamic memory might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage device 55, which might include, for example, a media drive 512 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 55 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot, a PCMCIA slot and card, and other fixed or removable storage units 522 and interfaces 520 that allow software and data to be transferred from the storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as an Ethernet, network interface card, WiMedia, IEEE 802.XX, or other interface), a communications port (such as for example, a USB port, IR port, RS232 port, Bluetooth® interface, or other port), or other communications interface. Software and data transferred via communications interface 824 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent component names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the components or functionality described or claimed as part of the component are all configured in a common package. Indeed, any or all of the various components of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A system for generating impact information based on likelihood of component defect occurrence determination, the system comprising:
one or more physical processors configured by machine-readable instructions to:
obtain supply chain information for a component acquired by a user from a supplier;
determine a likelihood of component defect occurrence based on the supply chain information, the defect likelihood reflecting the likelihood of defect occurrence for the component;
identify devices that use the component having the likelihood of component defect; and
effectuate presentation of the identified devices as an interactive information map.

2. The system of claim 1, wherein the supply chain information comprises component identification information, component purchase information, component use information, historical purchase information, purchase trends, irregularities in purchase trends, historical defect information and industry standards information.

3. The system of claim 1, wherein determining a likelihood of component defect occurrence comprises analyzing collected sets of component identification related data, component purchase related data, component use related data historical purchase related data including, historical defect related data, and industry standards related data to generate a component defect likelihood indicator.

4. The system of claim 1, wherein the one or more physical processors are further configured by machine-readable instructions to calculate a component defect likelihood indicator.

5. The system of claim 2, wherein the one or more physical processors are further configured by machine-readable instructions to assign specificity, relevance, confidence and weight to every one of component identification information, component purchase information, component use information, historical purchase information, historical defect information, and industry standards information based on relevance and relationship between each piece of information to one another.

6. The system of claim 5, wherein relevance and relationship are determined using user specified parameters and system generated parameters.

7. The system of claim 2, wherein the component identification information comprises a storage chassis having a specific model and functional specification supplied by a prime supplier, and wherein the historical purchase information comprises similar prices paid in the past to the prime supplier.

8. The system of claim 7, wherein the component purchase information comprises a purchase price that is comparatively below the purchase price for a similar storage chassis, and wherein the component use information comprises mission critical data that is stored using the storage chassis.

9. The system of claim 2, wherein the historical defect information comprises information on a large number of storage chassis having similar functional specification being identified as defective, and wherein the industry standard information comprises guidelines that require storage chassis to be manually verified for warranty.

10. A method for generating impact information based on likelihood of component defect occurrence determination, the method comprising:
obtaining supply chain information for a component acquired by a user from a supplier;
determining a likelihood of component defect occurrence based on the supply chain information, the defect likelihood reflecting the likelihood of defect occurrence for the component;
identifying devices that use the component having the likelihood of component defect; and
effectuating presentation of the identified devices as an interactive information map.

11. The method of claim 10, wherein the supply chain information comprises component identification information, component purchase information, component use information, historical purchase information, purchase trends, irregularities in purchase trends, historical defect information and industry standards information.

12. The method of claim 10, wherein determining a likelihood of component defect occurrence comprises analyzing collected sets of component identification related data, component purchase related data, component use related data historical purchase related data including, historical defect related data, and industry standards related data to generate a component defect likelihood indicator.

13. The method of claim 10, further comprising calculating a component defect likelihood indicator.

14. The method of claim 11, further comprising assigning specificity, relevance, confidence and weight to every one of component identification information, component purchase information, component use information, historical purchase information, historical defect information, and industry standards information based on relevance and relationship between each piece of information to one another.

15. The method of claim 14, further comprising determining relevance and relationship using user specified parameters and system generated parameters.

16. The system of claim 11, wherein the component identification information comprises a storage chassis having a specific model and functional specification supplied by a prime supplier, and wherein the historical purchase information comprises similar prices paid in the past to the prime supplier.

17. The system of claim 16, wherein the component purchase information comprises a purchase price that is comparatively below the purchase price for a similar storage chassis, and wherein the component use information comprises mission critical data that is stored using the storage chassis.

18. The system of claim 11, wherein the historical defect information comprises information on a large number of storage chassis having similar functional specification being identified as defective, and wherein the industry standard information comprises guidelines that require storage chassis to be manually verified for warranty.
